(19) United States
(12) Patent Application Publication
(10) Pub. No.: US 2014/0215229 A1
(43) Pub. Date: Jul. 31, 2014

(54) EXTENSION APPARATUS, SYSTEM, AND POWER SUPPLY METHOD

(71) Applicant: KABUSHIKI KAISHA TOSHIBA, Tokyo (JP)

(72) Inventor: Naoto ITO, Mitaka-shi (JP)

(21) Appl. No.: 14/017,032

(22) Filed: Sep. 3, 2013

Related U.S. Application Data
(63) Continuation of application No. PCT/JP2013/059048, filed on Mar. 27, 2013.

(30) Foreign Application Priority Data
Jan. 31, 2013 (JP) 2013-017766

(51) Int. Cl. G06F 1/26

(52) U.S. Cl. CPC G06F 1/263
USPC 713/300

(57) ABSTRACT

According to one embodiment, an extension apparatus is configured to be connected to an electronic device includes a first battery. The apparatus includes a second battery, a supply module, and a controller. The supply module is configured to supplying the device with either a first electric power generated by an AC power supply or a second electric power supplied from the second battery. The controller is configured to request the supply module to supply the device with the first electric power if time is within a setting time range, if a first remaining capacity of the first battery is smaller than a first setting value, and if a second remaining capacity of the second battery is smaller than a second setting value.

### CROSS REFERENCE TO RELATED APPLICATIONS

This application is a Continuation Application of PCT Application No. PCT/JP2013/059048, filed Mar. 27, 2013 and based upon and claiming the benefit of priority from Japanese Patent Application No. 2013-017766, filed Jan. 31, 2013, the entire contents of all of which are incorporated herein by reference.

### FIELD

Embodiments described herein relate generally to a technology of reducing concentration of use of an AC power supply.

### BACKGROUND

An electronic device, such as a notebook-type personal computer, can be driven by any of battery driving and external power supply (commercial power supply) driving (AC power supply driving). Therefore, an electronic device can be put on a desk and driven by an AC power supply or can be carried out to any other place and driven by the battery driving.

On the other side, an electronic device is provided with a peak shift function to reduce power consumption (power consumption by AC power supply driving) in a time zone when electric power is highly demanded. Owing to the peak shift function, supply from an AC power supply is stopped and switched to battery driving when the time enters a preset peak-shift time zone. Accordingly, power consumption can be reduced by the AC power supply driving.

At present, building a battery in an extension apparatus configured to be connected to a personal computer is considered. When an extension apparatus is connected, electric power is supplied from an AC power supply even in a time zone to which a peak shift applies. Demands for electric power concentrate consequently.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an example of exterior appearance of a system including an electronic device and an extension apparatus, according to an embodiment.

FIG. 2 is an exemplary block diagram showing a system configuration of the electronic device and extension apparatus, according to the embodiment.

FIG. 3 is an exemplary diagram showing relationships among modules, relating to a peak shift function according to the embodiment.

FIG. 4 is a diagram showing an example of a peak-shift setting screen according to the embodiment.

FIG. 5 is an exemplary flowchart showing a procedure of controlling electric power supplied to a personal computer by a controller.

FIG. 6 is an exemplary flowchart showing a procedure of controlling electric power supplied to a personal computer by a controller.

### DETAILED DESCRIPTION

Various embodiments will be described hereinafter with reference to the accompanying drawings.

In general, according to one embodiment, an extension apparatus is connected to an electronic device comprising a first battery. The apparatus includes a second battery, a supply module, and a controller. The supply module is configured to supplying the device with either a first electric power generated by an AC power supply or a second electric power supplied from the second battery. The controller is configured to request the supply module to supply the device with the first electric power if time is within a setting time range, if a first remaining capacity of the first battery is smaller than a first setting value, and if a second remaining capacity of the second battery is smaller than a second setting value.

### First Embodiment

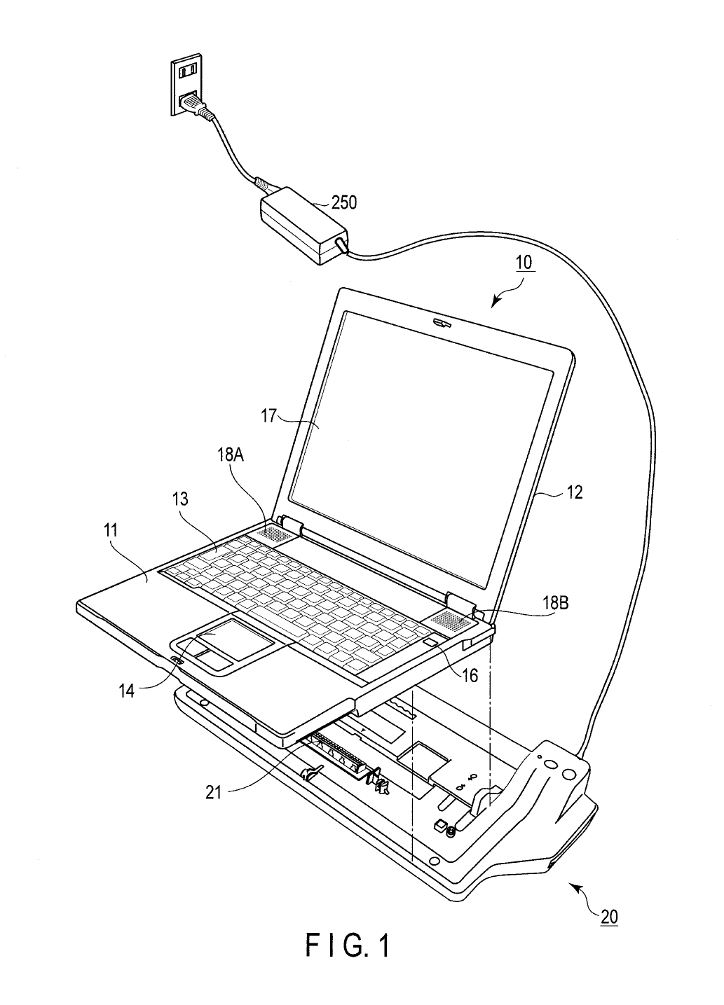

Firstly, a configuration of a system configured by an electronic device and an extension apparatus according to the first embodiment will be described with reference to FIGS. 1, 2, and 3. This electronic device can be realized as a tablet computer, a notebook-type personal computer, a smart phone, or a PDA. The present embodiment will be described with reference to a case that the electronic device is realized as a notebook-type personal computer 10 which can be driven by a battery and is portable.

FIG. 1 is a perspective view showing an opened display unit of a notebook-type personal computer and a docker as an extension apparatus.

The computer 10 is configured by a computer body 11 and a display unit 12. A display apparatus configured by a LCD (Liquid Crystal Display) 17 is built in a display unit 12. A display screen of the LCD 17 is positioned in the substantial center of the display unit 12.

The display unit 12 is attached to the computer body 11, to be freely pivotable between an opened position and a closed position. The computer body 11 has a housing having a thin box shape. On a top surface thereof, there are provided a keyboard 13, a touchpad 14, a power button 16 to power on/off this computer 10, and loudspeakers 18A and 18B.

The computer body 11 is provided with a power supply connector. An external power supply apparatus is detachably connected to the power connector. An AC adaptor can be used as an external power supply apparatus. The AC adaptor is a power supply apparatus which converts commercial external power (AC power) into DC power.

A battery is detachably attached to, for example, a rear end of the computer body 11. The battery may be built in the personal computer 10.

When the computer 10 is set on a docker 20 as an extension apparatus, a docking connector 21 provided in the docker 20 and a docking port provided in the back side of the computer 10 are connected to each other. When the computer 10 and the docker 20 are connected, drive power can be supplied to the computer 10 from the docker 20 and signals can be transmitted between the computer 10 and the docker 20.

A power supply connector is provided in a back surface of the docker 20. An external power supply apparatus is detachably connected to the power connector. An AC adaptor 250 can be used as the external power supply apparatus. The AC adaptor 250 is a power supply apparatus which converts commercial external power (AC power) into DC power.

When the docker 20 is connected, the personal computer 10 is driven by power from the docker 20 or by power from the battery in the personal computer 10 (AC power supply driving, battery driving). Usually, the personal computer 10 is driven by the power from the docker 20 when the docker 20 is connected. No AC adaptor is connected to the power supply connector of the personal computer 10 when the docker 20 is connected.

Also, the electric power from the docker 20 is used to electrically charge the battery in the personal computer 10. While the personal computer 10 is not connected to the docker 20 and while the external power supply apparatus is not connected to the power connector, the personal computer 10 is not driven by the power from a battery 140.

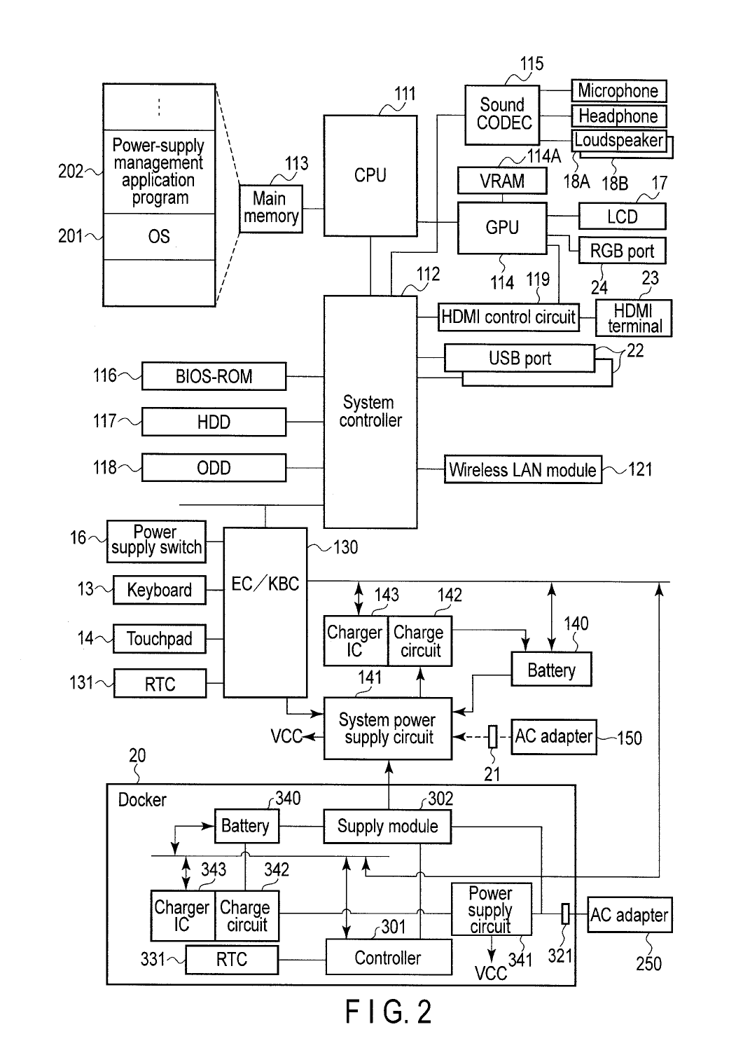

FIG. 2 shows the system configuration of the personal computer 10 and the docker, according to the embodiment.

The personal computer 10 comprises a CPU 111, a system controller 112, a main memory 113, a graphics processing unit (GPU) 114, a sound codec 115, a BIOS-ROM 116, a hard disk drive (HDD) 117, an optical disk drive (ODD) 118, a wireless LAN module 121, an embedded controller/keyboard controller IC (EC/KBC) 130, a RTC (Real Time Clock) 131, a system power supply circuit 141, a charge circuit 142, and a Charger IC 143.

The CPU 111 is a processor which controls operations of individual components of the personal computer 10. The CPU 111 executes various programs loaded to a main memory 113 from the HDD 117. The programs include an operating system (OS) and various application programs. The application programs include a power-supply management application program 202. The power-supply management application program 202 is a program to perform a peak shift function. The peak shift function is a function to reduce power consumption (power consumption by AC power supply driving) in a time zone when electric power is highly demanded.

Further, the CPU 111 also executes a basic input/output system (BIOS) stored in the BIOS-ROM 116 which is a nonvolatile memory. The BIOS is a system program for hardware control.

The GPU 114 is a display controller which controls a LCD 17 used as a display monitor of the personal computer 10. The GPU 114 generates a display signal (LVDS signal) to be supplied to the LCD 17 from display data stored in the video memory (VRAM) 114A. Further, the GPU 114 can also generate an analog RGB signal and a HDMI video signal from the display data. An analog RGB signal is supplied to an external display through an RGB port 24. A HDMI output terminal 23 can send the HDMI video signal (uncompressed digital image signal) and a digital audio signal to the external display by a cable. A HDMI control circuit 119 is an interface for sending the HDMI video signal and digital audio signal to the external display through the HDMI output terminal 23.

The system controller 112 is a bridge device which connects the CPU 111 and individual components to each other. The system controller 112 includes a serial ATA controller for controlling the hard disk drive (HDD) 117 and the optical disk drive (ODD) 118.

In addition, devices such as a USB port 22 and a wireless LAN module 121 are connected to the system controller 112.

Further, the system controller 112 performs communication with devices connected through a bus.

The EC/KBC 130 is connected to the system controller 112 through the bus. Also, the EC/KBC 130 is mutually connected to the Charger IC 143 and the battery 140 through the serial bus.

The EC/KBC 130 is an electric power management controller for performing electric power management of the personal computer 10, and is formed, for example, as a one-chip microcomputer with a built-in keyboard controller which controls the keyboard (KB) 13 and touchpad 14. The EC/KBC 130 has a function to power on/off the personal computer 10 in accordance with operations of the power supply switch 16 by the user. Power-on and power-off control of the personal computer 10 is performed on the system power-supply circuit 141 by the EC/KBC 130.

The RTC (Real Time Clock) 131 has a function of counting time.

The Charger IC 143 is an IC which controls the charge circuit 142 under control of the EC/KBC 130. The EC/KBC 130, Charger IC 143, and system power supply circuit 141 operate by electric power from the battery 140 or a AC adaptor 150 connected to the power supply connector 21 even during a period when the personal computer 10 is powered off.

The system power supply circuit 141 generates electric power (operation power supply) which is to be supplied to each of components by using electric power from any of the battery 140, the AC adaptor 150 connected as an external power supply to the computer body 11, and the docker. The system power supply circuit 141 also supplies electric power to electrically charge the battery 140 by the charge circuit 142.

The charge circuit 142 charges the battery 140 by using electric power supplied through the system power supply circuit 141 under control of the Charger IC 143.

The docker 20 comprises a controller 301, a supply module 302, a battery 340, a RTC (Real Time Clock) 331, a power supply circuit 341, a charge circuit 342, and a Charger IC 343.

The RTC (Real Time Clock) 331 has a function of counting time. The RTC 331 is not required if the controller 301 can obtain time information by serial communication from the RTC 131 provided in the personal computer 10.

The Charger IC 343 is an IC which controls the charge circuit 342 under control of the EC/KBC 301.

By using the electric power from the battery 340 or the electric power supplied via a power connector 321 from an AC adaptor 250 connected as an external power supply, the power supply circuit 341 can generate electric power (operation power supply) which is to be supplied to individual components in the docker 20 and to the personal computer 10. The power supply circuit 341 also supplies the electric power to electrically charge the battery 340 by the charge circuit 342.

The charge circuit 342 electrically charges the battery 340 by using electric power supplied through the power supply circuit 341 under control of the Charger IC 343.

The controller 301 manages electric power supplied to the personal computer 10. The controller 301 manages electric power supplied to the personal computer 10 at the time of a peak shift, based on the time counted by the RTC 331. At the peak shift, the controller 301 obtains a remaining capacity (hereinafter, body remaining capacity) of the battery 140 of the personal computer 10 (hereinafter, body battery), and a remaining capacity (docker remaining capacity) of the battery (hereinafter, docker battery) 340 through a bus at the peak shift. The controller 301 manages the electric power supplied to the personal computer 10, based on at least one of the body remaining capacity and the docker remaining capacity. In addition, the controller 301 obtains the time counted by the RTC 131 from the EC/KBC through a bus. Based on the obtained time, the controller 301 synchronizes the time of the RTC 131 with the time of the RTC 331. The supply module 302 supplies the personal computer 10 with the battery 340 or the electric power from the AC adaptor 250 in accordance with a request from the controller 301.

The controller 301 requests the Charger IC 343 to inhibit charging of the docker battery 340 at the time of the peak shift. The Charger IC 343 performs control of inhibition of charging of the docker battery 340 by the charge circuit 342.

Next, operation of the peak shift function of the personal computer 10 according to the embodiment will be described.

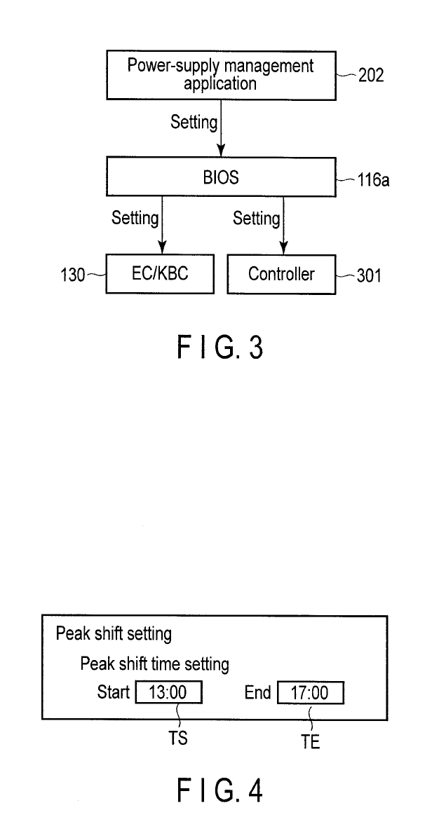

FIG. 3 is a diagram showing relationships among modules, relating to the peak shift function, according to the embodiment. Firstly, various settings relating to the peak shift function will be described.

The power-supply management application program 202 displays a setting screen on the LCD 17.

FIG. 4 is a diagram showing an example of a peak-shift setting screen according to the embodiment. Input areas TS and TE for a start time and an end time for setting the peak shift time are provided on the peak shift setting screen shown in FIG. 4. Setting data can be inputted to each of the areas TS and TE as a user operates the keyboard 13 or the touchpad 14.

In general, time when electric power is highly demanded is specified as peak shift time. In the example shown in FIGS. 4, 13:00 to 17:00 is set as an example of the peak shift time.

Setting data inputted by the power-supply management application program 202 is set in the EC/KBC 130 and the controller 301 via the BIOS 116A. That is, the setting data is recorded on a recording medium which can be accessed by the EC/KBC 130. Also, the setting data is recorded on the recording medium which can be accessed by the controller 301.

In addition, various settings described above may be executed by the power-supply management application program 202 but may be executed by an other utility program.

Next, electric power supply from the docker at the time of the peak shift will be described.

At the peak shift time, the controller 301 controls the electric power supplied to the personal computer 10 in accordance with the remaining capacity of the body battery 140 and the remaining capacity of the docker battery 220.

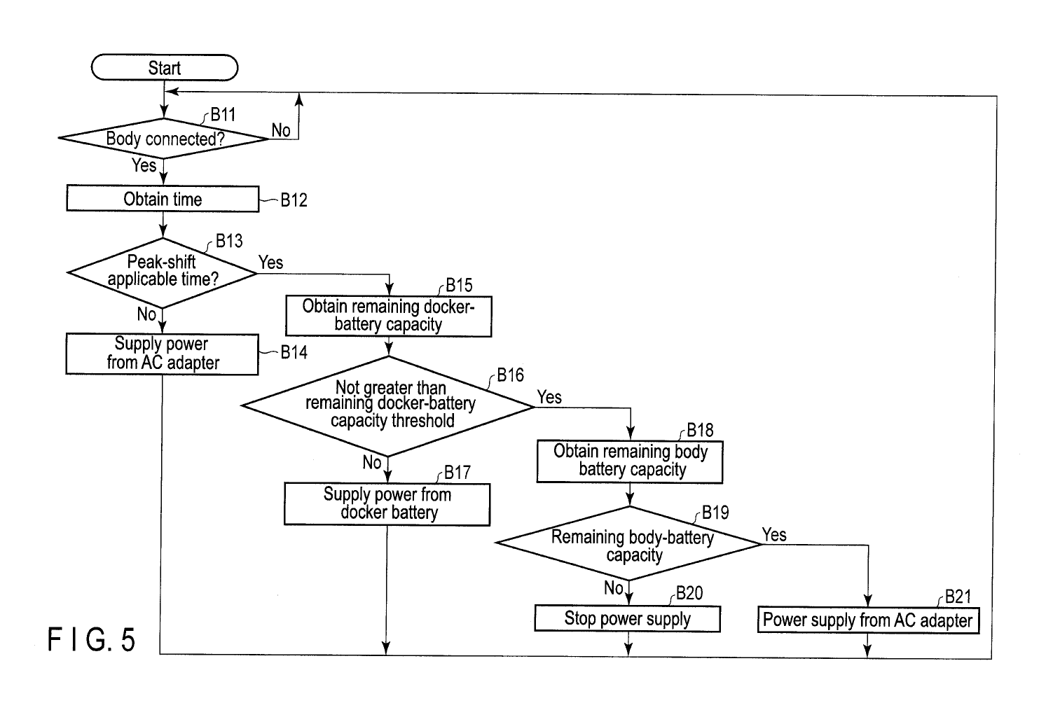

Control of the power supplied to the personal computer 10 by the controller 301 will be described with reference to the flowchart of FIG. 5.

The controller 301 determines whether the personal computer 10 is connected to the docker 20 or not (Step B11). If it is determined that the personal computer 10 is connected to the docker 20 (Yes in Step B11), the controller 301 receives the current time from the RTC 331 (Step B12). The controller 301 determines whether the current time is within a time range of a peak shift (Step B13). If it is determined that the current time is not within the time range of a peak shift (No in Step B13), the controller 301 requests the AC adapter 250 to supply electric power to the personal computer 10 (Step B14). If it is determined that the current time is within the time range of a peak shift (Yes in Step B13), the controller 301 receives a remaining capacity (hereinafter, docker remaining capacity) from the docker battery 340 (Step B15). The controller 301 determines whether the docker remaining capacity is not greater than a first threshold which has been set is determined (Step B16). If it is determined that the docker remaining capacity is greater than the first threshold (No in Step B16), the controller 301 requests the supply module 302 to supply electric power from the docker battery 340 to the personal computer 10 (Step B17). If it is determined that the docker remaining capacity is not greater than the first threshold (Yes in Step B16), the controller 301 receives a remaining capacity (hereinafter, body remaining capacity) of the body battery 140 (Step B18). The controller 301 determines whether the body remaining capacity is not greater than a second threshold which has been set (Step B19). If it is determined that the body remaining capacity is greater than the second threshold (No in Step B19), the controller 301 requests the supply module 302 to stop supply of electric power from the docker battery 340 and the AC adapter 250 to the personal computer 10 (Step B20). If it is determined that the body remaining capacity is not greater than the second threshold (Yes in Step B19), the controller 301 requests that electric power from the AC adapter 350 should be supplied to the personal computer 10 (Step B21).

If electric power is supplied from the docker 20, the personal computer 10 drives the body by using the power currently supplied from the docker. If electric power is not supplied from the docker 20, the body is driven by using the body battery 140.

### Second Embodiment

In the first embodiment, the docker battery 340 is preferentially used at the time of a peak shift. In the present embodiment, a body battery 140 is preferentially used at the time of a peak shift.

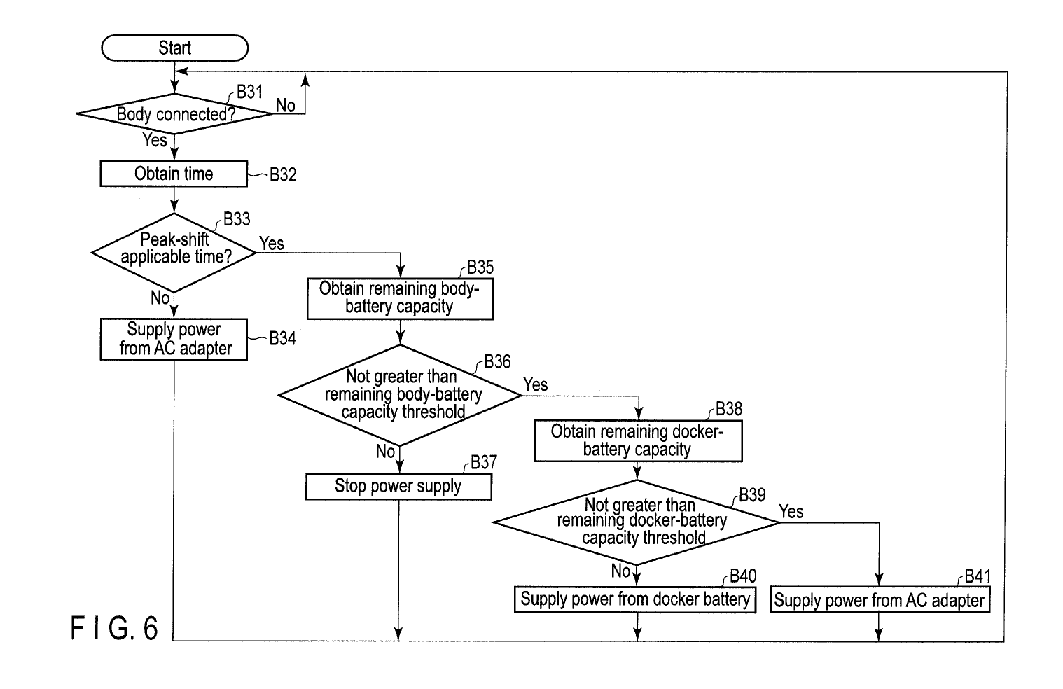

Control of electric power supplied to a personal computer 10 by a controller 301 will be described with reference to a flowchart in FIG. 6.

The controller 301 determines whether the personal computer 10 is connected (Step B31). If it is determined that the personal computer 10 is connected (Yes in Step B31), the controller 301 receives the current time from an RTC 331 (Step B32). The controller 301 determines whether the current time is within a time range of a peak shift (Step B33). If it is determined that the current time is not within the time range of a peak shift (No in Step B33), the controller 301 requests the supply module 302 to supply electric power from the AC adapter 250 to the personal computer 10 (Step B34). If it is determined that the current time is within the time range of a peak shift (Yes in Step B33), the controller 301 receives a remaining capacity (hereinafter, body remaining battery capacity) from the body battery 140 (Step B35). The controller 301 determines whether the body remaining battery capacity is not greater than a second threshold (Step B36). If it is determined that the body remaining battery capacity is greater than the second threshold (No in Step B36), the controller 301 requests the supply module 302 to stop supply of electric power from the docker battery 340 and the AC adapter 250 to the personal computer 10 (Step B37). If it is determined that the body remaining battery capacity is not greater than the second threshold (Yes in Step B36), the controller 301 receives a remaining capacity (hereinafter, docker remaining capacity) from the docker battery 340 (Step B38). The controller 301 determines whether the docker remaining capacity is not greater than a first threshold (Step B39). If it is determined that the docker remaining capacity is greater than the first threshold (No in Step B39), the controller 301 requests the supply module 302 to supply electric power from the docker battery 340 to the personal computer 10 (Step B40). If it is determined that the docker remaining capacity is not greater than the first threshold (Yes in Step B39), the controller 301 requests that electric power from the AC adapter 250 should be supplied to the personal computer 10 (Step B41).

If electric power is supplied from the docker 20, the personal computer 10 drives the body by using the power currently supplied from the docker. If electric power is not supplied from the docker 20, the body is driven by using the body battery 140.

If the time counted by the RTC 331 is within a time range which has been set, if the remaining capacity of the body battery 140 is not greater than the first threshold, and if the remaining capacity of the docker battery 340 is not greater than the second threshold, the controller 301 requests the supply module 302 to supply the electric power from the AC adaptor 250, thereby to become able to restrain supply from the AC adapter 250 to the personal computer 10 in case of a preset time range.

As has been described above, according to the first and second embodiments, if the remaining capacity of the body battery 140 is not greater than the first threshold and if the remaining capacity of the docker battery 340 is not greater than the second threshold at the time of a peak shift, the controller 301 requests the supply module 302 to supply electric power generated from the AC adaptor 250 to the personal computer 10, thereby to become able to restrain supplying electric power from the AC adapter 250 to the personal computer 10 at the time of a peak shift.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An extension apparatus configure to be connected to an electronic device comprising a first battery, the apparatus comprising:
a second battery;
a supply module configured to supplying the device with either a first electric power generated by an AC power supply or a second electric power supplied from the second battery; and
a controller configured to request the supply module to supply the device with the first electric power if time is within a setting time range, if a first remaining capacity of the first battery is smaller than a first setting value, and if a second remaining capacity of the second battery is smaller than a second setting value.

2. The apparatus of claim 1, wherein the controller is configured to request the supply module to supply the device with the second electric power if the time is within the setting time range and if the second remaining capacity is not smaller than the second setting value.

3. The apparatus of claim 2, wherein the controller is configured to request the supply module to stop supply of the first electric power and the second electric power if the time is within the setting time range, if the first remaining capacity is not smaller than the first setting value, and if the second remaining capacity is smaller than a second setting value.

4. The apparatus of claim 1, wherein the controller is configured to request the supply module to supply the device with the second electric power, if the time is within the setting time range, if the first remaining capacity is smaller than the first setting value, and if the second remaining capacity is not smaller than the second setting value.

5. The apparatus of claim 1, further comprising:
a first time count module configured to count time,
wherein the device further comprises a second time count module configured to count time, and
the apparatus further comprises a synchronization module configured to synchronize the time counted by the second time count module with the time counted by the first time count module.

6. The apparatus of claim 1, wherein
the device further comprises a time count module configured to count time, and
the apparatus further comprises an receiver configured to receive the time from the time count module.

7. The apparatus of claim 1, further comprising:
a charger module configured to electrically charge the second battery by using a third electric power generated by the AC power supply,
wherein the controller is configured request the charger module to stop charging the second battery if the time is within the setting time range.

8. A system comprising an electronic device and an extension apparatus configured to be connected to the electronic apparatus, wherein
the device comprises a first battery, and
the apparatus comprises
a second battery,
a supply component configured to supplying the device with either a first electric power generated by an AC power supply or a second electric power supplied from the second battery; and
a controller configured to request the supply module to supply the device with the first electric power if time is within a setting time range, if a first remaining capacity of the first battery is smaller than a first setting value, and if a second remaining capacity of the second battery is smaller than a second setting value.

9. A power supply method for an extension apparatus, which supplies an electronic device comprising a first battery with a first electric power generated by an AC power supply and a second electric power from a second battery, the method comprising:
supplying the device with the first electric power if time is within a setting time range, if a first remaining capacity of the first battery is smaller than a first setting value, and if a second remaining capacity of the second battery is smaller than a second setting value.
